(19) United States
(12) Patent Application Publication
(10) Pub. No.: US 2025/0019627 A1
(43) Pub. Date: Jan. 16, 2025

(54) BEER PRODUCTION PROCESS AND ASSOCIATED METHODS OF INCREASING THE SUGAR CONTENT OF WORT

(71) Applicant: H2O INNOVATION INC, Quebec (CA)

(72) Inventors: Rock GAULIN, Ham-Nord (CA); Matthieu FORTIER, Victoriaville (CA)

(21) Appl. No.: 18/350,968

(22) Filed: Jul. 12, 2023

(51) Int. Cl. C12C 7/26; C12C 7/165

(52) U.S. Cl. CPC C12C 7/26; C12C 7/165; C12C 2200/31

(57) ABSTRACT

The specification describes several examples of beer production processes, including a process including the steps of: mashing, including transferring sugar from grain-based solids to water, thereby producing wort; separating the wort from the grain-based solids; cooling the separated wort, including transferring heat from the separated wort to a cooling fluid; concentrating the sugar content of the cooled wort using membrane filtration, including separating water from the cooled wort; transferring heat from the separated wort to the concentrated wort; boiling the concentrated wort subsequently to said transferring heat from the separated wort to the concentrated wort; and fermenting the concentrated wort subsequently to said boiling.

### BACKGROUND

Methods of making beer have evolved over the last centuries, and in particular with industrialization. An example of an industrialized beer production process 10 is presented at FIG. 1. In this example, the process includes mashing 12 water and malt, lautering 14 the resulting wort from the solid residue, boiling 16 the wort, optionally with hops to provide additional flavor, cooling 18 the wort, introducing yeast to the cooled wort and fermenting 20, filtering 22, and bottling 22. The process as a whole is often referred to as brewing. The process can be repeated with a sequence of batches of ingredients, to produce a sequence of batches of beer. Typically, a given batch progresses from one station to another, as schematized in the example presented in FIG. 1, and a new batch may be started in the masher before the previous batch is bottled. Moreover, in the sequence, some steps may be started before previous steps are ended. For instance, lautering may take a certain amount of time and be performed at a given flow rate, such as between 8 and 15 gallons per minute, or between 10 and 12 gallon per minute, for instance, and the boiler may be activated to start heating the wort soon after it starts receiving some. In many cases, the process steps are actively controlled, or optimized in a manner to favor productivity of the equipment, with an objective of increasing the rate of batch production for a given facility.

While several variations to the example presented in FIG. 1 exist, many brewing methods involve a sequence of mashing 12, boiling 16, and fermenting 20. Mashing 12 can involve mixing a malt obtained from specially prepared grains such as barley with water, potentially with supplementary grains, and sustaining a temperature typically between 4° and 75° C. (˜105-165° F.). In some cases, the temperature is maintained constant, e.g. by heating to compensate for thermal loss during the mashing, whereas in other cases, step mashing is performed, including progressing through a sequence of increasing temperatures, each sustained for a given period of time, and each targeting the activation of distinct enzymes which break down associated elements of the malt and which can help release sugars from the malt. During mashing, sugars transfer from the solids of the malt to the water which becomes “wort”: a solution having a certain sugar content. The wort is then extracted from the solid residue in a process typically referred to as lautering, prior to boiling. While lautering can be performed in the same piece of equipment as the mashing, it is more common to transfer the mash from a dedicated masher to a dedicated lauterer and to perform the lautering with the lauterer. Boiling raises the temperature further to 102-103° C. (˜217° F.—above the usual boiling point of water due to the sugar content). The boiling can be sustained in a manner play the role of concentrating the sugar content (typically measured in the unit of degrees Brix—° Bx) of the wort by evaporating water, in addition to sterilizing the wort. The wort is then cooled, mixed with yeast, and fermented. During fermentation, the yeast transforms the sugars into alcohol. Higher alcohol content beers typically start with higher sugar content wort or use more than one fermentation step.

Many variations of beer production processes have been devised over the years and some are adapted to specific circumstances. For instance, in an industrial production, mashing, lautering, boiling, cooling and fermentation are typically performed in distinct pieces of equipment, but some variations remain depending on the specific application. In some cases, in an effort to increase the sugar yield of the grain, an additional process referred to as “sparging” is performed. Sparging involves the introduction of supplemental water to extract an additional portion of sugars which may remain in the malt following the initial mashing step. The sparging may be performed subsequently to lautering the initial mash, or while lautering the mash (e.g. by adding water at a flow rate comparable to the flow rate at which the wort is extracted from the lauterer), to name two examples. The supplemental water used for sparging can be referred to as “sparge water”. Separating sparge water from the solid residue may also be referred to as lautering. Sparging typically dilutes a given batch of wort to a certain extent, increasing the overall volume while lowering the overall sugar content, but can allow extracting a greater total amount of sugar from a given batch of malt, and thus increase the yield of a given batch of malt.

While methods of making beer have been satisfactory to a certain degree, there always remains room for improvement. For instance, raising the temperature of the wort to boiling temperature, and sustaining the boiling temperature for a given period of time, are energy consuming processes, especially when conducted in a manner to increase sugar content of the wort prior to fermenting. This can be particularly energy-intensive when increasing the sugar content to relatively high levels, such as when producing higher alcohol content beer (e.g. higher than 7% or 10% alcohol), or such as when starting the boiling off with wort having a lower sugar content.

### SUMMARY

The energy cost of bringing the wort to a boil and/or sustaining the boiling for a given period of time, for a given total mass of sugars in the wort, may be reduced by limiting the proportion of water in the wort upstream of the boiling. The proportion of water to sugar in the wort is the inverse of the sugar content. Sugar content can correspond to the proportion of sugar to water in the wort. Accordingly, the lower the sugar content, the more water mass is present in the wort proportionally to a given mass of sugar. Accordingly, the higher the sugar content of the wort immediately before boiling, the lower the amount of water for the associated mass of sugar. Consequently, a lower amount of energy is required to heat a batch of wort having a higher sugar content, for a given total mass of sugars, to reach the boiling point. Moreover, if boiling is used in a manner to reduce the proportion of water to sugar in the wort, such as to reach a higher, targeted, sugar content, the higher the sugar content is to begin with, the lower is the amount of energy used to reach the targeted sugar content.

One way to reduce the proportion of water in the wort is to introduce less water into the process, either by using less water during the initial mashing step, by using less water during the sparging step, or by omitting sparging entirely. This approach can have certain inconveniences. In particular, for example, reducing the amount of water introduced into the process may be performed at the cost of reducing the total sugar yield of a given batch of malt.

An alternate way of reducing the proportion of water in the wort is via membrane filtration (e.g. using a membrane having a pore size associated to reverse osmosis or nano-filtration). Indeed, membrane filtration can be used to separate permeate (e.g. water with only trace amounts—such as around 0.01% or less—of the sugars) from concentrate (e.g. water with the sugars or otherwise having a significantly higher sugar content), and thereby reduce the proportion of water to sugar in the wort. However, membrane filtration may not be suited to the temperature at which wort is provided (e.g. above 55° C., above 60° C., and typically between 65° C. and 77° C.), and only be suitable at lower temperatures (e.g. below 40° C., below 35° C.). In particular, the material of the membrane integrated in membrane filtration modules may not be suitable for use above such temperatures. When the intention is to reduce energy consumption, the idea of cooling the wort to make it suitable to membrane filtering, upstream of boiling may appear counter-productive, since one could then have to spend additional energy in heating it back up again.

It was found that at least in some embodiments, the energy cost associated with the cooling of the wort prior to membrane filtration could be alleviated or otherwise deemed acceptable. For instance, it was found that performing heat exchange between the wort concentrate, which may exit membrane filtration at a temperature below 40° C., and the source wort, which may exit lautering or mashing at a temperature above 65° C., may alleviate the energy costs associated to the cooling of the source wort upstream of the membrane filtration unit.

In another example, the source wort can be cooled by water which is then used as a source of warm or hot water in the same batch, such as for sparging, or in a subsequent batch, such as for mashing, in a manner to heat the water simultaneously to the cooling of the source wort. In this specification, water which becomes mixed into the wort at one point or another in the process will be referred to as process water, and this example can involve cooling the source wort with process water. While not directly alleviating the energy costs associated to the cooling of the source wort, this approach can nonetheless have a favorable effect on the overall energy costs, when considering the energy costs associated to the heating of the process water.

In a further example, water permeate from the membrane filtration can be used as process water (e.g. for sparging, in which case it can further be referred to as sparge water), and require less heating than an alternate source of sparge water, thereby offering an increase in energy efficiency compared to using an alternate source of sparge water in addition to potentially representing a reduction in water consumption since the permeate water originates from the process itself. Prior to being used as sparge water, water permeate may be further heated with the heat of the source wort upstream of the membrane filtration and simultaneously contribute to the upstream cooling of the source wort, which may have additional benefits from the point of view of energy efficiency. Moreover, it is common for breweries to produce process water by treating municipal water, e.g. via an osmosis treatment, and to thereby obtain process water having characteristics suitable to the brewing process. In such cases, recovering water permeate from membrane filtration as process water (e.g. for mashing or sparging), can further allow to leverage the water treatment which has already been performed upstream, as opposed to treating more municipal water, and thus alleviate the water treatment requirement.

Depending on the embodiment, cooling the source wort with the concentrated wort can be combined with cooling the source wort with process water (e.g. sparge water), and/or with using water permeate as process water (e.g. sparge water), or either one of these features may be used individually.

In accordance with one aspect, there is provided a process of increasing a sugar content of wort, the process comprising: providing source wort at a first temperature; cooling the source wort from the first temperature to a second temperature; circulating the source wort at the second temperature through a membrane filter, including separating water permeate from wort concentrate; said cooling including transferring heat from the source wort to the wort concentrate; and boiling the wort concentrate.

In accordance with another aspect, there is provided a process of increasing a sugar content of wort, the process comprising: providing source wort at a first temperature; cooling the source wort from the first temperature to a second temperature; circulating the source wort at the second temperature through a membrane filter, including separating water permeate from wort concentrate; said cooling including transferring heat from the source wort to the water permeate; and boiling the wort concentrate.

In accordance with another aspect, there is provided a process of increasing a sugar content of wort, the process comprising: providing source wort at a first temperature; cooling the source wort from the first temperature to a second temperature; circulating the source wort at the second temperature through a membrane filter, including separating water permeate from wort concentrate; said cooling including transferring heat from the source wort to process water; boiling the wort concentrate; and feeding the process water into the source wort.

In accordance with another aspect, there is provided a process of producing beer incorporating any one of the aspects presented above between mashing and boiling.

In accordance with yet another aspect, there is provided a process of producing beer, the process comprising: mashing, including transferring sugar from grain-based solids to water, thereby producing wort; separating the wort from the grain-based solids; cooling the separated wort, including transferring heat from the separated wort to a cooling fluid; concentrating the sugar content of the cooled wort using membrane filtration, including separating water from the cooled wort; transferring heat from the separated wort to the concentrated wort; boiling the concentrated wort subsequently to said transferring heat from the separated wort to the concentrated wort; and fermenting the concentrated wort subsequently to said boiling.

Many further features and combinations thereof concerning the present improvements will appear to those skilled in the art following a reading of the instant disclosure.

### DESCRIPTION OF THE FIGURES

In the figures,

FIG. 1 is a diagram representing an example of a brewing process;

FIG. 2 is a diagram representing an example method of increasing a sugar content of wort;

FIG. 3 is a diagram representing an example brewing process;

FIG. 4 is a diagram representing an example method of increasing a sugar content of wort.

### DETAILED DESCRIPTION

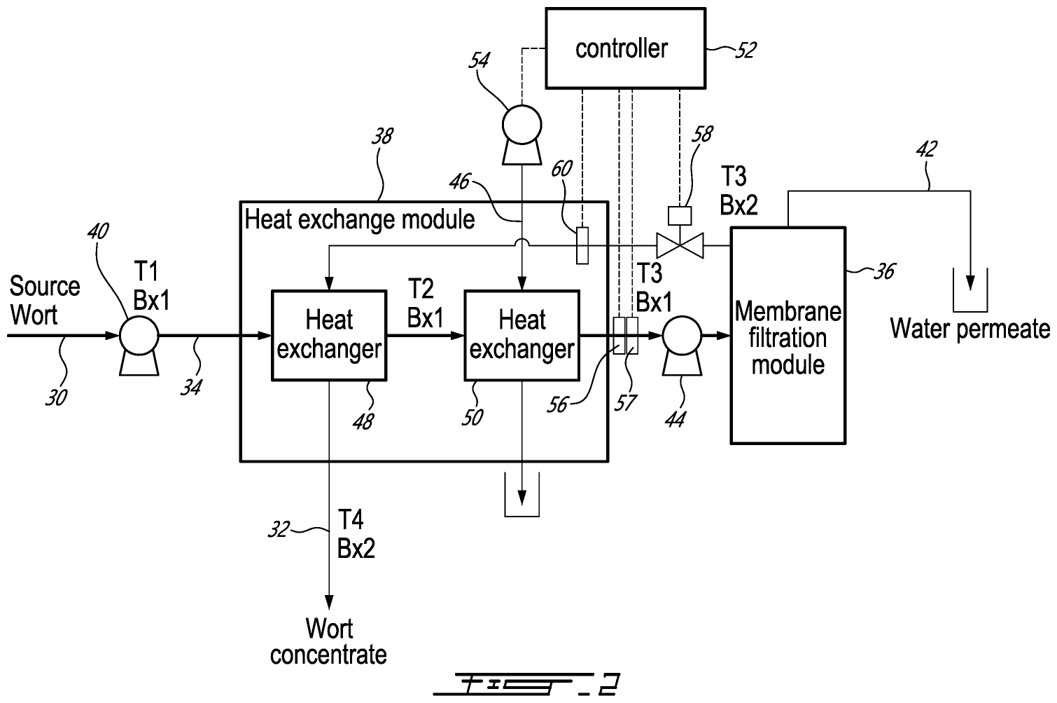

FIG. 2 shows an example of a process of increasing a sugar content of wort, including elements of an associated system. The process operates on wort, and can thus be performed subsequently to mashing, lautering and/or sparging. The wort feed into the process will be referred to herein as “source” wort 30, to distinguish it from the wort concentrate 32 resulting from membrane filtration. In this example, the source wort 30 is circulated along a first liquid conduit 34 between a wort source (e.g. masher or lauterer) and a membrane filtration module 36, across a heat exchange module 38.

The source wort 30 can be circulated by gravity or by a pump. In the example illustrated, the source wort 30 is circulated by a circulation pump 40. The wort 30 can be circulated at any suitable flow rate, and the specifications and/or configuration of the heat exchanger module and of the membrane filtration module can be selected as a function of the expected flow rate. The flow rate can be between 8 and 15 gallons per minute (GPM) for instance, or between 10 and 12 GPM for instance, in an example embodiment. Upstream of the heat exchange module 38, the source wort 30 may be at a first temperature (T1) and a first sugar content (Bx1). Between the heat exchange module 38 and the membrane filtration module 36, the source wort 30 may be at a second temperature (T3), having been cooled in the heat exchange module 38, while remaining at the first sugar content (Bx1). The source wort 30 can be circulated in the membrane filtration module 36 at the second temperature (T3).

The membrane filtration module 36 can have a inlet receiving the source wort 30, a permeate outlet ejecting the water permeate 42, and a concentrate outlet ejecting the wort concentrate 32. The membrane filtration module 36 can separate the source wort 30 into wort concentrate 32 (concentrated wort at a higher sugar content—Bx2) and water permeate 42 (relatively pure water), and thus extract water from the source wort, thereby concentrating the source wort 30. Membrane filtration in the membrane filtration module 36 may involve increasing the pressure of the source wort to a pressure between 500 and 1000 psi at the inlet of the membrane filtration module 36. In this example, the increase in pressure is provided by a membrane filtration pump 44.

A cooling fluid 46 is circulated across the heat exchange module 38 in a manner to extract heat from the wort 30 (i.e. cool the wort) while remaining fluidly partitioned from the wort 30 in the heat exchange module 38. The cooling fluid 46, which is at a temperature colder than the temperature of the source wort 30, is circulated in thermal contact with the source wort 30. The nature of the cooling fluid 46 can vary depending on the embodiment and can be cold (e.g. refrigerated) water, or a dedicated coolant such as glycol, to name two examples. The concentrate (wort concentrate 32) and the permeate (water permeate 42) can exit the membrane filtration module 36 roughly at the same temperature it entered it, e.g. T3, and typically back to atmospheric pressure.

The difference between T1 and T3 can be affected by the flow rate of cooling fluid 46 across the heat exchange module 38. In an embodiment, the flow rate can be adjusted in an automated, or semi-automated manner (e.g. with a proportional integral—PI, or with a proportional integral derivative—PID control loop) in a manner to reach a targeted T3 temperature. In one example, T1 can be above 135° F., such as between 145° F. and 175° F. for instance, and T3 may be below 110° F., such as between 100° F. and 85° F. for instance. The flow rate of permeate may be significantly greater than the flow rate of concentrate. For instance, in an example having a source wort 30 flow rate of 10 GPM, the water permeate 42 may have a flow rate of 6-7 GPM while the wort concentrate 32 may have a flow rate of 3-4 GPM. The cooling fluid may be at a temperature below ambient temperature, such as below 50° F. or below 40° F. When exiting the heat exchanger, the wort concentrate 32 may have a temperature T4 which is significantly greater than T3, though lower than T1. For instance, in an example, when T1 is at 145° F., T3 is at 95° F., T4 may be at 125° F., which is only 20° F. lower than T1. Achieving a T4 which is within 40° F. of T1, preferably within 30° F. of T1, can be suitable in many applications.

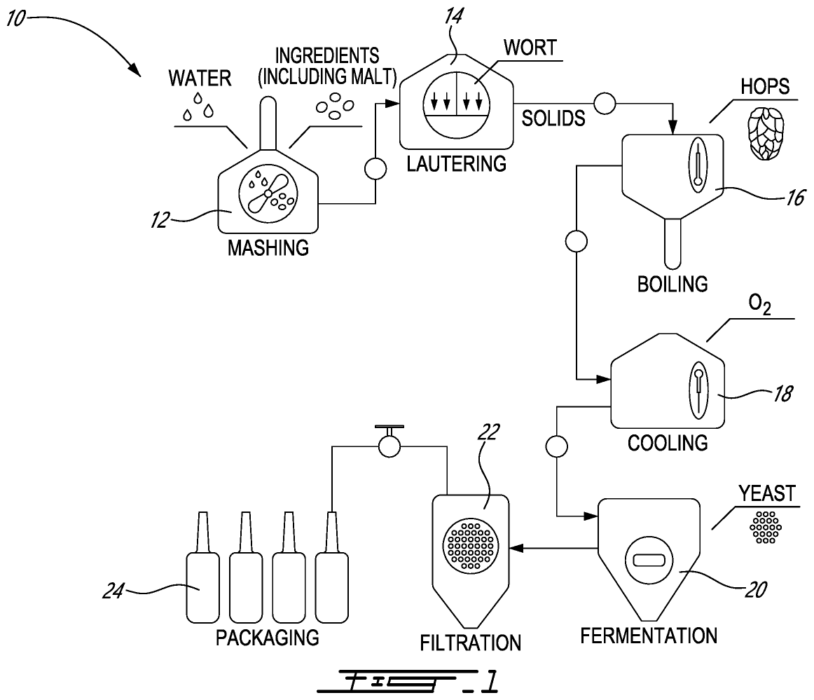

The heat exchange module 38 may include one or more heat exchangers 48, 50. In the example presented in FIG. 1, the heat exchange module 38 includes two heat exchangers 48, 50, and the source wort 30 reaches an intermediary temperature T2 between the first heat exchanger 48 and the second heat exchanger 50. More specifically, the cooling fluid 46 exchanges heat with the source wort 30 in the second heat exchanger 50, and the wort concentrate 32 from the membrane filtration is circulated in heat transfer relationship with the source wort 30 in the first heat exchanger 48, upstream of the second heat exchanger 50. More specifically, in an initial portion of the process of increasing the sugar content, the cooling may entirely be provided by the cooling fluid 46, and in a second portion of the process, as the cooled wort concentrate 32 becomes available at a suitable, a portion of the cooling may then be provided by the wort concentrate 32, simultaneously heating the wort concentrate 32. The flow rate of cooling fluid 46 through the second heat exchanger may be reduced between the first portion and the second portion of the process. A steady state mode of operation may occur during the second portion of the process. Accordingly, due to the heat exchange between the wort concentrate 32 and the source wort 30, less energy may be used to heat the wort concentrate 32 to boiling in a subsequent step of the beer production process, and less cooling fluid flow rate or cooling fluid heat exchange surface may be used to cool the source wort 30 than if the source wort 30 had not previously been cooled by the wort concentrate 32.

The flow rate of cooling fluid 46 may be controlled in real time in an automated or partially automated manner via a controller 52. More specifically, the controller 52 can control a cooling fluid pump 54 to circulate more or less cooling fluid in the heat exchanger 50 based on the temperature T3, which can be sensed via an appropriate temperature sensor 56. The controller 52 can operate on the basis of a PI or PID control loop for instance to reach a target temperature T3.

Similarly, the sugar content of the wort concentrate 32 may be controlled in real time in an automated or partially automated manner via a controller 52 which may or may not share hardware and/or software resources with the controller which controls the flow rate of cooling fluid. More specifically, the controller 52 can control a pressure inside the membrane filtration module via a valve 58 restricting the flow out the concentrate outlet. The controller may also sense the sugar content via a suitable sugar content sensor 60. The controller 52 can operate on the basis of a PI or PID control loop for instance to reach a target sugar content Bx2.

In an embodiment, the water permeate 42 may be used as process water and introduced into source wort of the current batch or of a next batch. Indeed, water permeate 42 may result from water which has already been treated at an earlier stage of the process, and may be warmer than water otherwise available to the process. In another embodiment, the water permeate 42 may be released to the environment. The cooling fluid 46 can be cold water released to the environment subsequently to the heat exchanger 50, or recycled in a cooling circuit having a refrigeration unit, to name some examples.

The heat exchange module 38 can be provided in the form of a single heat exchange device including a plurality of heat exchanger sections in series, or a plurality of distinct heat exchanger units connected to one another in sequence. For instance, in one example, the heat exchanger module can be a plate heat exchanger module such as the hygienic line of plate heat exchanger modules manufactured by ALFA LAVAL Corporate AB in Canada. More specifically, plate heat exchanger modules can be configured in a manner to have more than one section provided in series, and a single unit can thus be configured with a first section where the wort concentrate is circulated in thermal exchange contact with the source wort, and with a second section where the source wort is circulated in thermal exchange contact with the cooling fluid. Many variants are possible in alternate embodiments.

The membrane filtration module 36 can include a single membrane filtration stage, a plurality of membrane filtration stages in parallel, a plurality of membrane filtration stages in series, or a plurality of membrane filtration stages both in parallel and in series. Membrane filtration stages can each include a housing internally partitioned by a membrane. The concentrate can circulate between an inlet and a concentrate outlet on a first side of the membrane, and the permeate can circulate along the other side of the membrane. The permeate can cross the membrane while the concentrate remains on the first side of the membrane. The nature of the molecules which are intended to remain in the concentrate can affect the choice of membrane. In particular, to concentrate sugar, the pore size of the membrane can be of around 0.001 micron for instance, and the membrane can be a soft water desalination membrane, a reverse osmosis membrane or a nanofiltration membrane, for instance.

In an embodiment, the membrane filtration module 36 can be configured in a manner for the pressure to be adaptable to variations in the sugar content. In particular, membrane filtration may operate more efficiently with a higher operating pressure when the sugar content is higher. The system may include a sugar content sensor 57 provided upstream of the membrane filtration module 36, which may measure the sugar content, and the controller, 52, can adapt the pressure at one or more locations in the membrane filtration module 36 on the basis of the signal received from the sugar content sensor 57. Moreover, the membrane filtration system may have more than one membrane filtration stage in series, each operating at increasing pressures, or a recirculation loop which can increase the pressure as the sugar content increases over recirculating time.

In an embodiment, the flow rate through the system may also be controlled as a function of the sugar content of the wort. In particular, the sugar content of the source wort may vary over time. For instance, when initially received from the lautering, the source wort may be at a relatively high sugar content, such as around 30° Br for instance, whereas it may be at a relatively low sugar content, such as around 2° Br for instance, at a later point in the process, such as when stemming from sparging rather than initial lautering. More specifically, a given membrane filtration unit may not offer a satisfactory if the controller targets an output sugar content which is too high relative to an inlet sugar content, and it may be preferable to reduce the target sugar content as a function of the inlet sugar content. Moreover, it may be better in some embodiments to reduce the targeted recovery ratio (recovery ratio=inlet sugar content/outlet sugar content) as a function of the inlet sugar content.

In an example, the controller can be provided with control data which can, for example, be in the form of a table. Table 1, below, presents a possible example of such a table:

TABLE 1
Example control data

| Inlet sugar | Outlet sugar | Flow rate | Recovery ratio | |
|---|---|---|---|---|
| content (°Br) | content | (gpm) | (%) | Mode |
| 17 | 34 | 8 | 50 | Brix |
| 16 | 32 | 8 | 50 | Brix |
| 15 | 30 | 8 | 50 | Brix |
| 14 | 30 | 8.5 | 54 | Brix |
| 13 | 30 | 9 | 54 | Brix |
| 12 | 30 | 9.5 | 57 | Brix |
| 11 | 30 | 10 | 63 | Brix |
| 10 | 30 | 10.5 | 67 | Brix |
| 9 | 30 | 11 | 70 | Brix |
| 8 | 30 | 11.5 | 74 | Brix |
| 7 | 30 | 12 | 77 | Brix |
| 6 | 30 | 12.5 | 80 | Max ratio |
| 5 | 25 | 13 | 80 | Max ratio |
| 4 | 20 | 13.5 | 80 | Max ratio |
| 3 | 15 | 14 | 80 | Max ratio |
| 2 | 10 | 14.5 | 80 | Max ratio |

Accordingly, in the latter example, the mode can change as a function of the measured inlet sugar content. More specifically, in this specific example, the control mode can be in a min ratio mode when the inlet sugar content is above a given threshold (e.g. 14° Br) in which the targeted sugar content increases as a function of increasing inlet sugar content; in a max ratio mode when the inlet sugar content is below a given threshold (e.g. 7° Br) in which the targeted sugar content decreases as a function of decreasing inlet sugar content, and an intermediary mode in which the targeted sugar content does not vary as a function of inlet sugar content. Moreover, in the specific example presented above, the flow rate is reduced based on increasing inlet sugar content in both max ratio and brix mode, but then remains fixed independently of inlet sugar content in min ratio mode. In other words, in some embodiments, not only may the flow rate through the membrane be adjusted based on the inlet sugar content in a manner to achieve a targeted outlet sugar content, but the targeted outlet sugar content may be adjusted based on the inlet sugar content. In some embodiments, the flow rate through the membrane filtration module may increase as a function of lowering inlet sugar content. Many variants are possible in alternate embodiments.

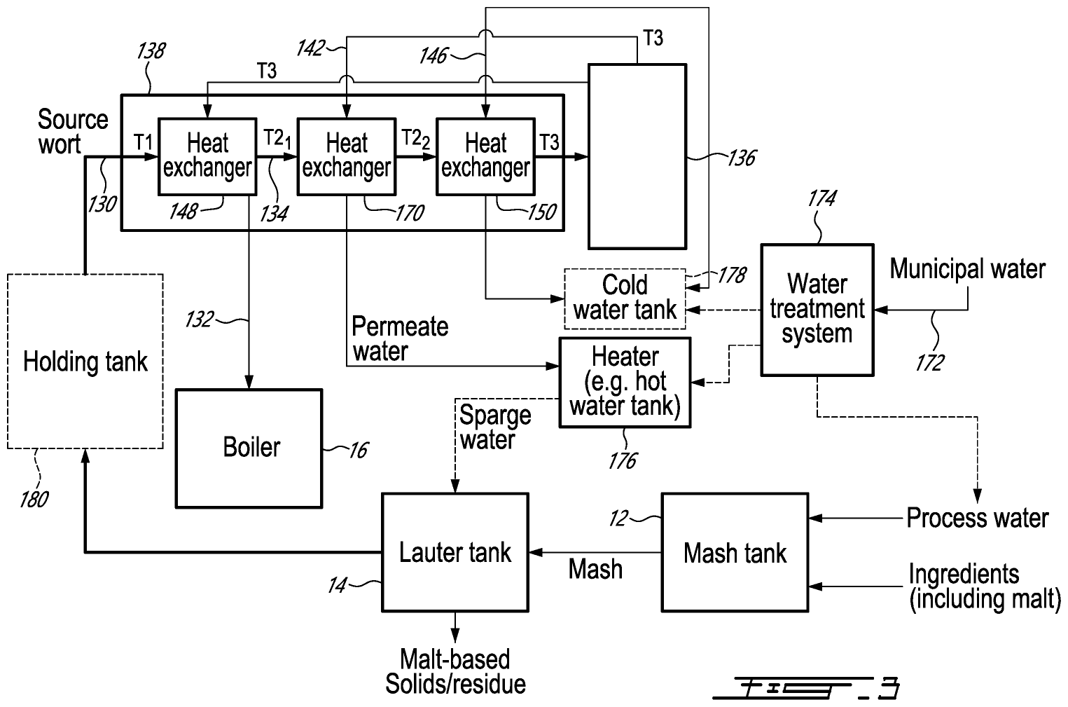

FIG. 3 presents another embodiment of a process of increasing sugar content of wort. The process presented in FIG. 3 bears similarities with the process presented in FIG. 2 in that the source wort 130 is circulated along a first liquid conduit 134 to a membrane filtration module 136, across a heat exchange module 138, and that the source wort 130 is cooled both by a cooling fluid 146 and by the wort concentrate 132 in the heat exchange module. However, in this embodiment, the source wort 130 is further cooled by the water permeate 142. More specifically, another heat exchanger 170 is present where the water permeate 142 is circulated in heat exchange contact with the source wort 130. In this example, the additional heat exchanger 170 is placed in series between the first 148 and the second 150 heat exchangers, and an intermediary temperature T2₁ of the wort may be achieved between the first heat exchanger 148 and the additional heat exchanger 170, and an intermediary temperature T2₂ may be achieved between the additional heat exchanger 170 and the second heat exchanger 150. The intermediary temperature T2₂ may be lower than the intermediary temperature T2 achieved in the embodiment presented in FIG. 2 due to the cooling from the water permeate and accordingly, less cooling may be required from the cooling fluid.

Moreover, in this embodiment, rather than being disposed of, the water permeate is used as process water and introduced into source wort 130, either of the current batch, or into a next batch. In this specific example, the permeate water extracted from the source wort 130 resulting from mashing can more specifically be used for sparging the malt-based solids. Indeed, sparging may be conducted with water above 110° F., such as water at 145° F. for instance. Preparing water for sparging (or for mashing) may involve treating municipal water 172, such as with an osmosis process for instance, and heating the treated water to sparge water temperature (e.g. 145° F. in an example), which can thus use energy, water and water treatment capacity. Accordingly, by using permeate water, an available by-product of membrane filtration in this context, for sparging, energy, water and water treatment capacity may be saved, especially when taking into consideration a context where water permeate 146 has already passed through the water treatment system 174 upstream in the process, and may thus not require any additional treatment than heating, and less heating than other sources of water may have required. In the illustrated embodiment, a heater 176 such as may, for example, be integrated to a hot water tank, is used to heat the permeate water up to a temperature suitable for sparging. This heater may be a dedicated heater. Alternately, a brewing facility may have a hot water tank holding hot, treated water, which may have an integrated heater. In such cases, the permeate water may simply be returned to the hot water tank for further heating upstream of a second use as sparge water. In an alternate embodiment, the permeate water 146 may be used as process water but for the mashing of a subsequent batch rather than for sparging, or for both mashing and sparging. The wort concentrate 132 may be conveyed to a boiler 16.

In an embodiment, the brewing facility may further have a cold water tank 178 holding refrigerated, treated water. In an embodiment, the cooling fluid 146 may be water from the cold water tank 178, and be returned to the cold water tank 178, for instance. In one or more embodiment, water from the cold water tank 178 and/or water from the hot water tank can be used as process water, such as for mashing or for sparging. In an embodiment, water from the hot water tank can be mixed with water from the cold water tank 176 in a fixed or varying proportions, such as to achieve a targeted temperature for a given phase of the process. In an embodiment where water from the hot water tank is mixed with water from the cold water tank in varying proportions to reach a temperature suitable to a use as process water in a phase of the process, such as for mashing or for sparging, the proportions can be controlled via a controller based on the reading of a temperature sensor and via one or more associated actuator valves, for instance.

In one embodiment, the source wort 130 may be conveyed to a holding tank 180 upstream of the heat exchanger module 138. In another embodiment, the source wort 130 may be fed directly from a lauter tank 14 or from a mash tank 12 to the heat exchange module 138, and the flow rate of the cooling fluid 146 can be adapted by the controller 52 in real time to achieve a suitable temperature T3 upstream of the membrane filtration module 136.

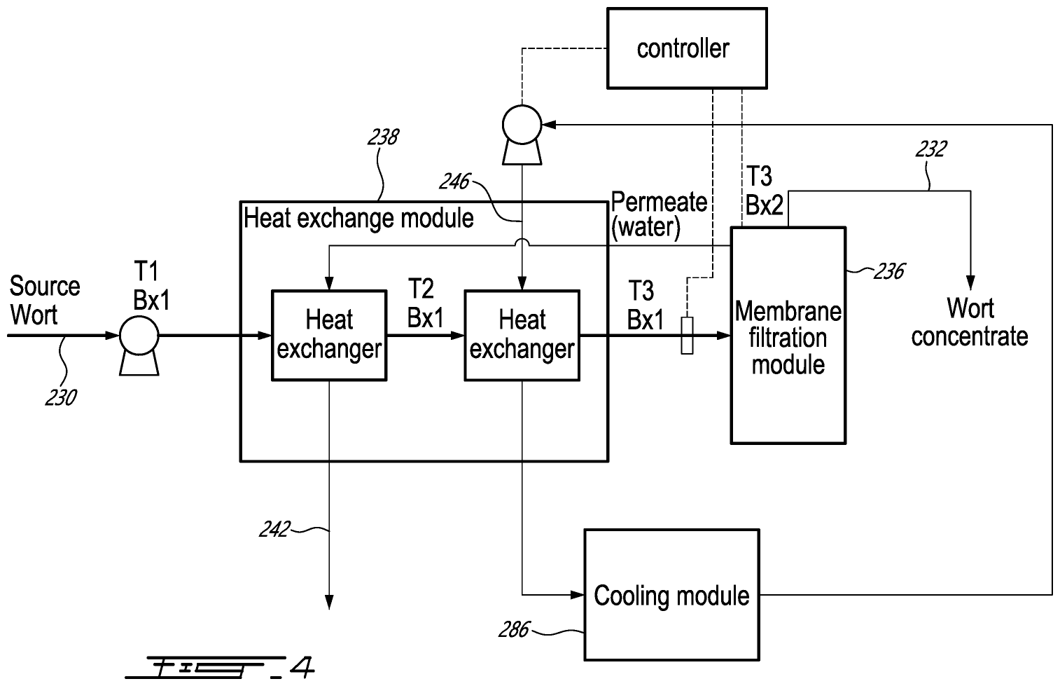

FIG. 4 presents yet another example of a process of increasing a sugar content of wort. This embodiment has similarities with the examples described in reference to FIGS. 2 and 3, in that source wort 230 is cooled in a heat exchange module 238 upstream of a membrane filtration module 236 where it is separated into water permeate 242 and wort concentrate 232. In this example as well, circulation of a cooling fluid 246 is also involved in the cooling of the source wort 230 upstream of the membrane filtration module 238. However, in this example, the wort concentrate 232 is not used for cooling the source wort 230, and only the water permeate 242 is used for cooling the source wort 232. Such an embodiment may be useful in some embodiments since it may allow to reduce the cooling capacity associated to the cooling fluid used in the cooling of the source wort 232. Moreover, in some embodiments, the water permeate 242, having been heated by the source wort, can be used as process water, such as for mashing or for sparging, which may provide an additional energy and possibly water saving.

In the example presented in FIG. 4, the cooling fluid 246 is a coolant, and a cooling module 286, which can include a heat pump having a refrigerant circuit engaged in heat exchange contact with the coolant circuit, can be used to extract heat from the cooling fluid 246.

As can be understood, the examples described above and illustrated are intended to be exemplary only, and various alternatives and different combinations of elements can be used in alternate embodiments. For instance, in alternate embodiments, different ones of the heat exchangers forming part of a heat exchange module may be connected in parallel rather than in series. The scope is indicated by the appended claims.

What is claimed is:

1. A process of increasing a sugar content of wort, the process comprising:
providing source wort at a first temperature;
cooling the source wort from the first temperature to a second temperature;
circulating the source wort at the second temperature through a membrane filter, including separating water permeate from wort concentrate;
said cooling including transferring heat from the source wort to the wort concentrate; and
boiling the wort concentrate.

2. The process of claim 1 wherein the cooling further includes transferring heat from the source wort to process water, and feeding the process water into the source wort.

3. The process of claim 2 said feeding the process water into the source wort includes sparging, and includes exposing the process water to malt-based solids and transferring sugars from the malt-based solids to the process water.

4. The process of claim 3 wherein the process water is the water permeate.

5. The process of claim 1 wherein said cooling further includes transferring heat from the source wort to the water permeate.

6. The process of claim 1 wherein said cooling further includes transferring heat from the source wort to a cooling fluid, further comprising measuring a temperature of the source wort between the cooling and the circulating, and controlling the flow rate of cooling fluid based on the temperature of the source wort.

7. The process of claim 6 wherein said providing source wort includes receiving the source wort from one of a mash tank and a lautering tank.

8. The process of claim 1 wherein said providing source wort includes receiving the source wort from one of a mash tank and a lautering tank, further comprising measuring a sugar content of the wort concentrate and controlling the flow rate of wort concentrate based on the sugar content.

9. The process of claim 8 further comprising measuring a sugar content of the source wort, determining a targeted sugar content for the wort concentrate based on the measured sugar content of the source wort, and wherein said controlling the flow rate of wort concentrate based on the sugar content includes adjusting the flow rate of wort concentrate in a manner for the measured sugar content of the wort concentrate to meet the targeted sugar content.

10. A process of increasing a sugar content of wort, the process comprising:
providing source wort at a first temperature;
cooling the source wort from the first temperature to a second temperature;
circulating the source wort at the second temperature through a membrane filter, including separating water permeate from wort concentrate;
said cooling including transferring heat from the source wort to the water permeate; and
boiling the wort concentrate.

11. The process of claim 10 further comprising sparging, the sparging including exposing the water permeate to malt-based solids and transferring sugars from the malt-based solids to the water permeate, into at least a portion of the source wort.

12. The process of claim 10 wherein said cooling further includes transferring heat from the source wort to a cooling fluid, further comprising measuring a temperature of the source wort between the cooling and the circulating, and controlling the flow rate of cooling fluid based on the temperature of the source wort.

13. The process of claim 12 wherein said providing source wort includes receiving the source wort from one of a mash tank and a lautering tank.

14. The process of claim 13 further comprising measuring a sugar content of the wort concentrate and controlling the flow rate of wort concentrate based on the sugar content.

15. A process of increasing a sugar content of wort, the process comprising:
providing source wort at a first temperature;
cooling the source wort from the first temperature to a second temperature;
circulating the source wort at the second temperature through a membrane filter, including separating water permeate from wort concentrate;
said cooling including transferring heat from the source wort to process water;
boiling the wort concentrate; and
feeding the process water into the source wort.

16. The process of claim 15 wherein said feeding the process water into the source wort includes sparging, and includes exposing the process water to malt-based solids and transferring sugars from the malt-based solids to the process water.

17. The process of claim 15 wherein the process water includes the water permeate.

18. The process of claim 15 wherein said cooling further includes transferring heat from the source wort to a cooling fluid, further comprising measuring a temperature of the source wort between the cooling and the circulating, and controlling the flow rate of cooling fluid based on the temperature of the source wort.

19. The process of claim 18 wherein the cooling fluid is at least some of the process water.

20. The process of claim 18 wherein said providing source wort includes receiving the source wort from one of a mash tank and a lautering tank.

21. The process of claim 15 wherein said providing source wort includes receiving the source wort from one of a mash tank and a lautering tank, further comprising measuring a sugar content of the wort concentrate and controlling the flow rate of wort concentrate based on the sugar content.
